(19) United States
(12) Patent Application Publication
(10) Pub. No.: US 2008/0180748 A1
(43) Pub. Date: Jul. 31, 2008

(54) Print data processing apparatus and method, and computer readable recording medium

(75) Inventor: Hisashi Moriya, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 11/976,541

(22) Filed: Oct. 25, 2007

(30) Foreign Application Priority Data
Jan. 26, 2007 (JP) 2007-016175

(51) Int. Cl. G06F 15/00

(52) U.S. Cl. 358/1.17

(57) ABSTRACT

A position designation unit of a print data processing apparatus designates a position of identification information in each page of data to be printed, the identification information identifying the page. An extraction unit extracts the identification information contained in each page of the data, based on the position designated by the position designation unit. A memory stores the identification information extracted by the extraction unit and the data corresponding to the page containing the identification information, the identification information being associated with the data. An input unit inputs print object information containing the identification information indicating a page to be reprinted. A controller performs a control operation so that the data of the page corresponding to the print object information input from the input unit is output from the memory, based on the print object information input from the input unit and the identification information stored in the memory.

### CROSS-REFERENCE TO RELATED APPLICATIONS

This application is based on and claims priority under 35 USC 119 from Japanese Patent Application No. 2007-16175 filed Jan. 26, 2007.

### BACKGROUND

1. Technical Field

The present invention relates to a print data processing apparatus and method, and a computer readable recording medium.

2. Related Art

Conventionally, printers that hold drawing data (such as print data) for which printing has been completed within the printers, and that reprint (re-output) all pages or a certain page in accordance with the necessity of a user, are known.

In a case where page numbers are not allotted to the pages of an output recording medium, however, a user needs to check which page is the page to be re-output when print data which has been already outputted is to be re-output. This hinders efficient reprinting of predetermined pages.

### SUMMARY

According to an aspect of the invention, a print data processing apparatus includes: a position designation unit that designates the position of identification information in each page of data to be printed, the identification information identifying the page; an extraction unit that extracts the identification information contained in each page of the data, based on the position designated by the position designation unit; a memory that stores the identification information extracted by the extraction unit and the data corresponding to the page containing the identification information, the identification information being associated with the data; an input unit that inputs print object information containing the identification information indicating a page to be reprinted; and a controller that performs a control operation so that the data of the page corresponding to the print object information input from the input unit is output from the memory, based on the print object information input from the input unit and the identification information stored in the memory.

### BRIEF DESCRIPTION OF THE DRAWINGS

Exemplary embodiments of the present invention will be described in detail based on the following figures, wherein:

FIG. 1 is a schematic view of a print data processing apparatus in accordance with a first exemplary embodiment of the present invention;

FIG. 2 shows the reprint information in accordance with the first exemplary embodiment of the present invention;

FIG. 3 shows a print sheet having an image formed thereon based on print data that is output from the output device in accordance with the first exemplary embodiment of the present invention;

FIG. 4A and FIG. 4B is a flowchart of a first print data converting routine to be executed by the processing device in accordance with the first exemplary embodiment of the present invention;

FIG. 5 shows a schematic view of a print data processing apparatus in accordance with a second exemplary embodiment of the present invention;

FIG. 6 shows the reprint information in accordance with the second exemplary embodiment of the present invention;

FIG. 7A and FIG. 7B is a flowchart of a second print data converting routine to be executed by the processing device in accordance with the second exemplary embodiment of the present invention;

FIG. 8 is a schematic view of a print data processing apparatus in accordance with a third exemplary embodiment of the present invention;

FIG. 9A and FIG. 9B is a flowchart of a third print data converting routine to be executed by the processing device in accordance with the third exemplary embodiment of the present invention;

FIG. 10 shows the reprint information in accordance with the third exemplary embodiment of the present invention; and

FIG. 11 is an explanatory diagram of the re-output keyword designation unit of the first through third exemplary embodiments.

### DETAILED DESCRIPTION

The following is a description of print data processing devices as exemplary embodiments of the present invention, with reference to the accompanying drawings.

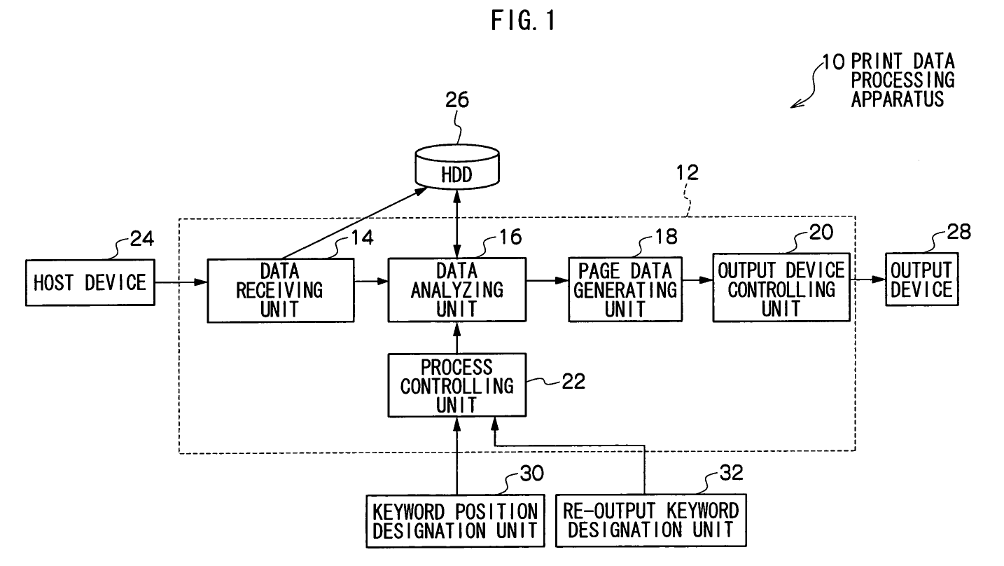

As shown in FIG. 1, a print data processing apparatus 10 of a first exemplary embodiment of the present invention includes a processing device 12. The processing device 12 is a microcomputer including: a ROM (not shown) that is a recording medium storing a program for executing a first data converting routine (described later in detail), a program for executing a processing routine to cause an output device 28 to output a print sheet on which an image based on print data input from a host device 24 is formed, and programs for executing various processing routines; a CPU (not shown) that reads a program from the ROM and executes each of the processing routines; a RAM (not shown) that temporarily stores data; an I/O (input/output) port (not shown); and a bus (not shown) that connects the ROM, the CPU, the RAM, and the I/O port to one another. The functional blocks of the microcomputer that executes the first data converting routine and the processing routine for causing the output device 28 to output a print sheet having an image formed thereon based on print data input from the host device 24 can be represented by a data receiving unit 14, a data analyzing unit 16, a page data generating unit 18, an output device controlling unit 20, and a process controlling unit 22.

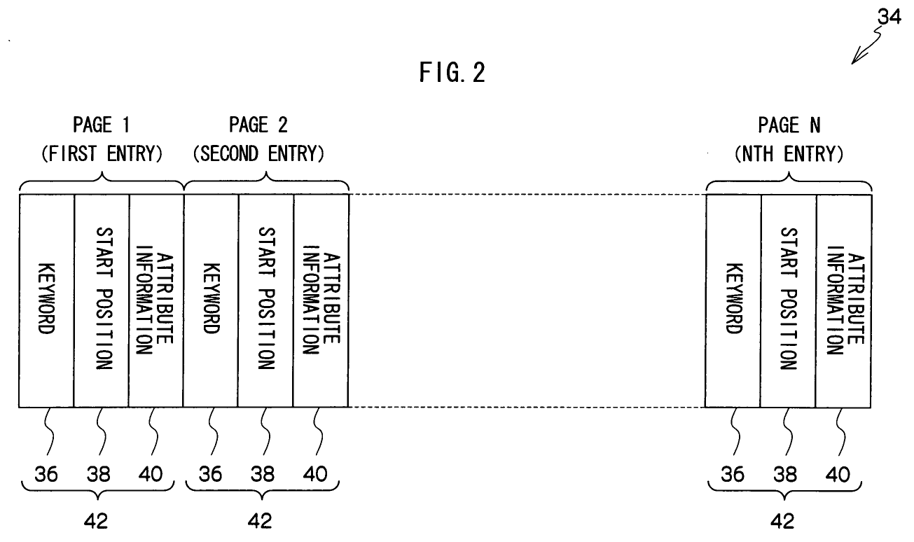

The data receiving unit 14 is connected to the host device 24 that outputs print data for performing printing in accordance with an instruction or the like from a user, and to a memory device 26 including a HDD (hard disk drive) that stores the print data that is input from the host device 24, a reprint information table 34 shown in FIG. 2, and various kinds of information. In the reprint information table 34, and the information required for performing reprinting are registered for each page of the print data.

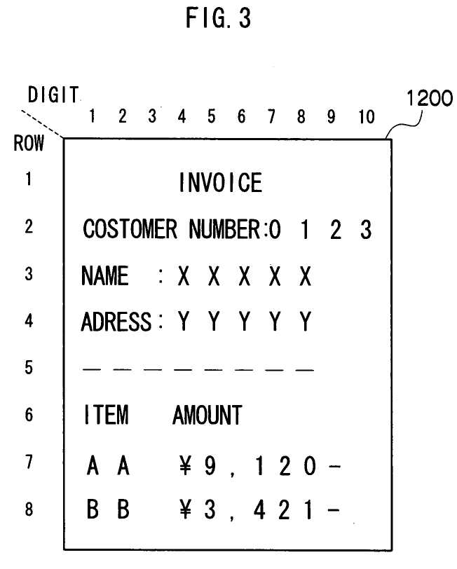

The data analyzing unit 16 is connected to the memory device 26. The output device controlling unit 20 is connected to the output device 28 that outputs a print sheet 1200 such as a ledger sheet on which an image based on the print data input from the host device 24 is formed, as shown in FIG. 3.

The process controlling unit 22 is connected to a keyword position designation unit 30 that designates the position of a keyword so as to extract the keyword as the identification information for identifying each page of the print data input from the host device 24, and a re-output keyword designation unit 32 that inputs a keyword indicating the page to be reprinted so as to designate the page to be reprinted.

The processing routine, which is executed by the CPU of the processing device 12, to cause the output device 28 to output a print sheet on which an image based on the print data input from the host device 24 is formed is now described.

When the print data is input from the host device 24 to the processing device 12, the input print data is stored in the memory device 26, and is converted into intermediate data. The intermediate data is then converted into bitmap data. The output device 28 is controlled to output an image based on the bitmap data. This operation is performed by the respective functional blocks of the data receiving unit 14, the data analyzing unit 16, the page data generating unit 18, and the output device controlling unit 20 in the following procedures [1] through [4]:

[1] The data receiving unit 14 receives the print data input from the host device 24, and stores the received print data in the memory device 26.

[2] The data analyzing unit 16 analyzes the print data received by the data receiving unit 14, and converts the print data into intermediate data.

[3] The page data generating unit 18 generates bitmap data from the intermediate data converted by the data analyzing unit 16, or converts the intermediate data into the bitmap data.

[4] The output device controlling unit 20 controls the output device 28 to output an image based on the bitmap data generated by the page data generating unit 18.

In the above described manner, after the print data is input from the host device 24 to the processing device 12, a paper sheet or the like on which an image based on the print data is formed is output from the output device 28.

Next, a method to be utilized by the keyword position designation unit 30 to designate the position of a keyword contained in each page of the print data is described. The keyword position designation unit 30 includes a keyboard (not shown) and a display (not shown), for example. In the keyword position designation unit 30, the keyword position information including the row and digit at which the character at the top of the keyword to be designated is positioned, and the number of characters in the keyword are input through an input screen (not shown) on the display with the use of the keyboard. For example, based on the print data input from the host device 24 to the processing device 12, as shown in FIG. 3, a user designates the position of the keyword contained in each page in a case where a print sheet 1200 such as a ledger sheet having the positions of items (such as a customer number, name, and address) preset in an image is output from the output device 28 in the following manner.

To designate a four-digit number following “Customer Number:” as the keyword contained in each page, for example, the user inputs the keyword position information indicating that the row of the position of the keyword to be designated is “2”, the digit is “7”, and the number of characters is “4” through the input screen on the display, using the keyboard, if the row of the position of the first character (“0” in FIG. 3) of the four-digit number following “Customer Number:” is “2” and the digit is “7”. As the keyword position information is input to the processing device 12, the CPU of the processing device 12 stores the input keyword position information in the memory device 26. This operation is performed by the process controlling unit 22 and the data analyzing unit 16. As will be described later in detail, the data analyzing unit 16 extracts the keyword contained in each page of the print data input from the host device 24, based on the keyword position information that is input here.

Next, the method to be utilized by the re-output keyword designation unit 32 to input print object information containing a keyword (a re-output keyword) as the identification information indicating the page to be re-output is described. The re-output keyword designation unit 32 includes a keyboard (not shown) and a display (not shown), for example. Print object information containing a re-output keyword is input through an input screen 1108 on the display, as shown in FIG. 11, with the use of the keyboard.

A user inputs a keyword that is in the position designated by the keyword position designation unit 32 and indicates a page to be reprinted, through an input field 1100. When a keyword is input to the input field 1100, the user inputs total print page number information through an input field 1102. The total print page number information indicates the total number of pages (the number of pages to be reprinted, for example) starting from the page indicated by the keyword input to the input field 1100 to the page at which the reprinting is to end. When a keyword is input to the input field 1100, the user also inputs end identification information (a keyword indicating the page at which the reprinting is to end, for example) through an input field 1104. The end identification information indicates the page at which the reprinting starting from the page indicated by the keyword input to the input field 1100 is to end. When a keyword is input to the input field 1100 and the page indicated by the keyword input to the input field 1100 is the page of the back face of a two-sided print sheet, the user ticks a check box 1106 so as to indicate that printing is to be performed not only on the back face but also on the front face of the same print sheet.

As described above, the user inputs the print object information through the input screen 1108 on the display, as shown in FIG. 11, using the keyboard.

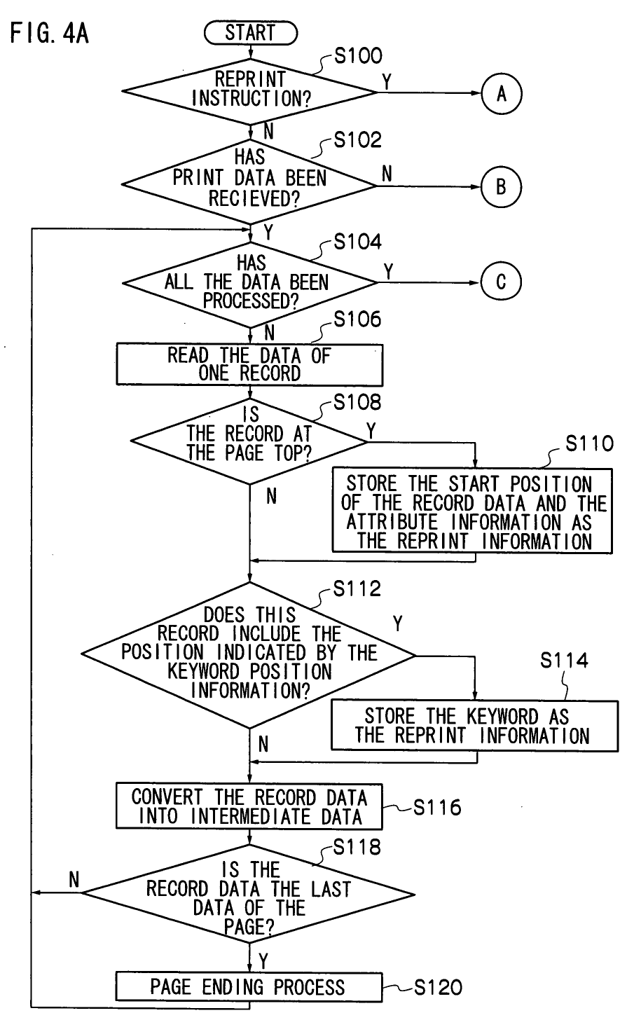

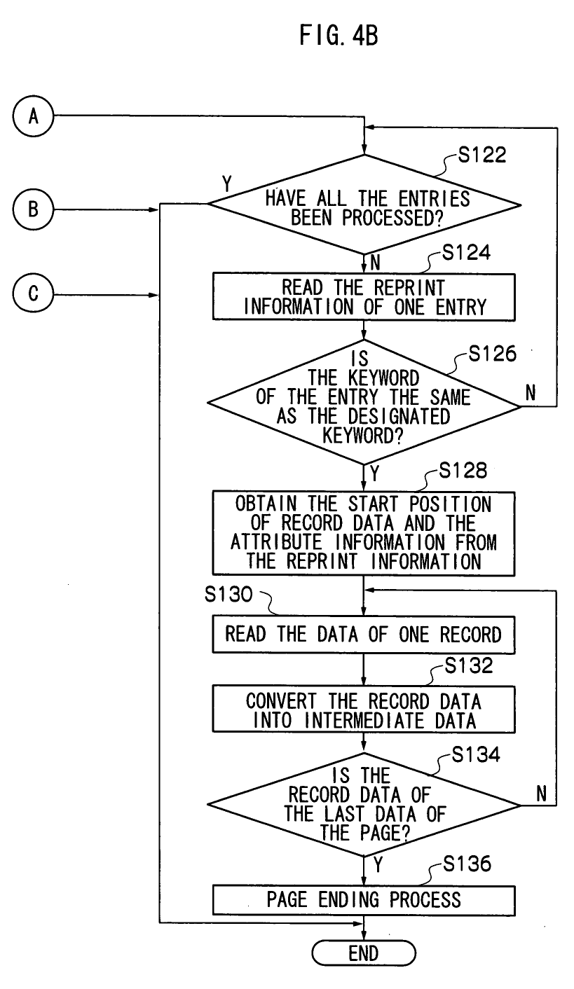

Referring now to FIG. 4A and FIG. 4B, the first data converting routine to be executed by the CPU of the processing device 12 is described. When the switch (not shown) of the print data processing apparatus 10 is switched on to supply power, this data converting routine is repeatedly executed.

At step 100, a check is made to determine whether there is a reprint instruction, or whether a keyword indicating a page to be reprinted (re-output) is input from the re-output keyword designation unit 32.

If there is a reprint instruction at step 100, the operation moves on to step 122, and the procedures of steps 122 through 136 that will be described later in detail are carried out, so as to convert the print data for reprinting, such as the print data of the page represented by the keyword input from the re-output keyword designation unit 32, into intermediate data.

If there is not a reprint instruction at step 100, a check is made to determine whether print data is received from the host device 24 at step 102. If the print data is not received at step 102, the data converting routine comes to an end. If the print data is received at step 102, the procedures of steps 104 through 120 that will be described later in detail are carried out, so as to extract the keyword that is contained in the received print data and identifies each page of the print data, and to associate the extracted keyword with the print data of the corresponding page.

First, a case where the keyword that is contained in the received print data and identifies each page of the print data is extracted, and the extracted keyword is associated with the print data of the corresponding page is described in the following.

At step 104, a check is made to determine whether the read-in process to be carried out at step 106 has been carried out for all the record data in the received print data. If the read-in process is determined to have been carried out for all the record data at step 104, the data converting routine comes to an end. If the read-in process is determined not to have been carried out for all the record data at step 104, the operation moves on to the next step 106.

At step 106, the data of one record that has not been read yet and is the closest to the page top among the record data in the received print data is read in.

At step 108, a check is made to determine whether the record data read in at step 106 is the record data of the page top. If the read record data is determined not to be the record data of the page top at step 108, the operation moves on to step 112. If the read record data is determined to be the record data of the page top at step 108, an entry 42 for one page is newly created in the reprint information table 34 stored in the memory device 26 and shown in FIG. 2. The information indicating the position of the record data in the received print data (such as the byte number counted from the top of the print data) is stored at the sub entry 38 of the newly created entry 42 in the reprint information table 34. Attribute information including the print information contained in the record data is also stored at the sub entry 40 of the entry 42, and the operation moves on to step 112. Here, the print information indicates the sheet size, whether the current printing is one-side printing or two-sided printing, or whether the current printing is for a front face or a back face. The information indicating the position of the record data in the received print data is also the information (data) indicating the start position of the corresponding page in the received print data.

At step 112, the keyword position information input from the keyword position designation unit 30 is read out from the memory device 26, and a check is made to determine whether the record data read in at step 106 includes the position indicated by the keyword position information which is read out from the memory device 26. If the read record data is determined not to include the position indicated by the keyword position information which is read out from the memory device 26 at step 112, the operation moves on to step 116. If the read record data is determined to include the position indicated by the keyword position information which is read out from the memory device 26, the operation moves on to step 114, and the keyword located in the position indicated by the keyword position information is extracted from the record data read in at step 106. The extracted keyword is then stored at the sub entry 36 of the corresponding entry 42 in the reprint information table 34 stored in the memory device 26, and the operation moves on to step 116.

At step 116, the record data read in at step 106 is converted into intermediate data, and the operation moves on to step 118. At step 118, a check is made to determine whether the record data read in at step 106 is the last record data of the page. If the read record data is determined not to be the last record data of the page at step 118, the operation returns to step 104, and the above described procedures are repeated. If the read record data is determined to be the last record data of the page at step 118, the operation moves on to step 120. At step 120, a page ending process is carried out to integrate the intermediate data of each record converted at step 116 into the intermediate data of one page.

As described above, through the procedures of steps 104 through 120, the keyword identifying each page of the received print data is extracted, and the extracted keyword is associated with the print data of the corresponding page.

An example case where a print sheet 1200 such as a ledger sheet having the positions of items (such as the customer number, name, and address) fixed in an image as shown in FIG. 3 is output from the output device 28 based on the print data input from the host device 24 to the processing device 12 is described. For example, in a case where a user inputs keyword position information indicating that the row number is “2”, the digit number is “7”, and the number of characters is “4” as the keyword contained in each page through the keyword position designation unit 30 so as to designate the four-digit number following “Customer Number:”, the four-digit number following “Customer Number:” of each page of the print data is extracted as the keyword identifying each page at step 114. The extracted keyword is then stored at the sub entry 36 of the entry 42 of the corresponding page in the reprint information table 34 stored in the memory device 26.

Next, a case where the print data for reprinting, such as the print data of the page indicated by the keyword input from the re-output keyword designation unit 32, is converted into intermediate data for reprinting is described below.

At step 122, a check is made to determine whether all the entries 42 of the reprint information table 34 stored in the memory device 26 have been read in at step 124. If all the entries 42 of the reprint information table 34 are determined to have been read in at step 122, the data converting routine comes to an end. If not all the entries 42 of the reprint information table 34 are determined to have been read in at step 122, the operation moves on to step 124.

At step 124, one entry is read in from the entries 42 in the reprint information table 34 that have not been read stored in the memory device 26 and are the closest to the top.

At step 126, a check is made to determine whether the keyword contained in the sub entry 36 of the entry 42 read in at step 124 is the same as the keyword designated through the re-output keyword designation unit 32. If the keyword contained in the sub entry 36 of the read entry 42 is determined not to be the same as the designated keyword at step 126, the operation returns to step 122. If the keyword contained in the sub entry 36 of the read entry 42 is determined to be the same as the designated keyword at step 126, the operation moves on to step 128.

At step 128, the information indicating the position of the start of the corresponding page in the print data contained in the sub entry 38 of the entry 42 and the attribute information contained in the sub entry 40 are obtained from the entry 42 containing the keyword that is determined to be the same as the designated keyword at step 126.

At step 130, based on the information indicating the position of the start of the page in the print data obtained at step 128, the print data of the corresponding page is detected among the print data stored in the memory device 26, and one record is read in from the record data that is in the print data of the detected page and has not been converted into intermediate data at step 132.

At step 132, the record data of the one record read in at step 130 is converted into intermediate data.

At step 134, a check is made to determine whether the record read in at step 130 is the last record of a page. If the record is determined not to be the last record of the page at step 134, the operation returns to step 130. If the record is determined to be the last record of the page at step 134, the operation moves on to step 136. At step 136, a page ending process is carried out to integrate the intermediate data of the respective records converted at step 132 into the intermediate data of one page.

As described above, through the procedures of steps 122 through 136, the print data for reprinting, such as the print data of the page indicated by the keyword input from the re-output keyword designation unit 32, is converted into intermediate data.

For example, in a case where a four-digit number (“0123”, for example) following “Customer Number:” is input as the re-output keyword from the re-output keyword designation unit 32, the print data of the page having the four-digit number “0123” following “Customer Number:” is converted into intermediate data for reprinting at steps 128 through 136.

Step 100 of the first data converting routine is carried out by the process controlling unit 22, step 102 is carried out by the data receiving unit 14, and steps 104 through 136 are carried out by the data analyzing unit 16.

The intermediate data converted from the print data is converted into bitmap data by the page data generating unit 18. The output device controlling unit 20 then controls the output device 28 to output a print sheet on which an image on the basis of the bitmap data is formed.

The keyword indicating a page to be reprinted and the total print page number information indicating the total number of pages starting from the page indicated by the keyword to the page at which the reprinting is to end may be input through the re-output keyword designation unit 32. In this case, at step 128 of the first data converting routine, the information indicating the position of the start of the corresponding page in the print data contained in the sub entries 38 and the attribute information contained in the sub entries 40 are obtained from the total page numbers, indicated by the total print page information, of entries 42 containing the entries 42 each containing the keyword determined to be the same as the designated keyword at step 126. At steps 130 through 134, based on the information indicating the position of the start of the corresponding page in the print data obtained at step 128, the print data of the corresponding page is detected among the print data stored in the memory device 26, and the detected print data is converted into intermediate data.

The keyword indicating a page to be reprinted and the keyword (the end identification information) indicating the page at which the reprinting starting from the page indicated by the keyword is to end may be input through the re-output keyword designation unit 32. In this case, at steps 122 through 126 of the first data converting routine, the entry 42 containing the same keyword as the keyword indicating the page to be reprinted, and the entry 42 containing the same keyword as the keyword indicating the page at which the reprinting is to end, are detected. At step 128, the information indicating the position of the start of the corresponding page in the print data contained in the sub entries 38 and the attribute information contained in the sub entries 40 are obtained from the entries 42 of the pages ranging from the entry 42 detected as the entry 42 containing the same keyword as the keyword indicating the page to be reprinted to the entry 42 detected as the entry 42 containing the same keyword as the keyword indicating the page at which the reprinting is to end. At steps 130 through 134, based on the information indicating the position of the start of the corresponding page in the print data obtained at step 128, the print data of the corresponding page is detected from the print data stored in the memory device 26, and the detected print data is converted into intermediate data.

In a case where the page indicated by the keyword indicating the page to be reprinted is the back face of the page in a two-sided printing operation, it is also possible to input through the re-output keyword designation unit 32 the keyword indicating page to be reprinted and an instruction indicating that the reprinting is to be performed not only on the back face of the subject page but also on the front face of the subject page. In this case, at step 128 of the first data converting routine, the information indicating the position of the start of the corresponding page in the print data contained in the sub entries 38 and the attribute information contained in the sub entries 40 are obtained from the entry 42 corresponding to the back face indicated by the same keyword as the designated keyword at step 126 and the entry 42 of the front face of the same page as the back face. At steps 130 through 134, based on the information indicating the position of the start of the corresponding page in the print data obtained at step 128, the print data of the corresponding page is detected from the print data stored in the memory device 26, and the detected print data is converted into the intermediate data.

The method to be utilized by the keyword position designation unit 30 to designate the position of the keyword contained in each page of print data may be a method for designating a character string accompanied with the keyword is located in the position to be designated. For example, in a case where the output device 28 is to output a print sheet 1200 such as a ledger sheet having the positions of the respective items (such as a customer number, name, and address) fixed in an image in advance, as shown in FIG. 3, based on print data that is input from the host device 24 to the processing device 12, a user may designate the position of the keyword contained in each page in the following manner. To designate a four-digit number following “Customer Number:” as the keyword contained in each page, the user may input the keyword position information indicating that the keyword to be designated should follow the character string “Customer Number:”. For example, the character string to be accompanied with the keyword, such as the character string “Customer Number:”, may be input through the input screen on the display with the use of the keyboard.

### SECOND EXEMPLARY EMBODIMENT

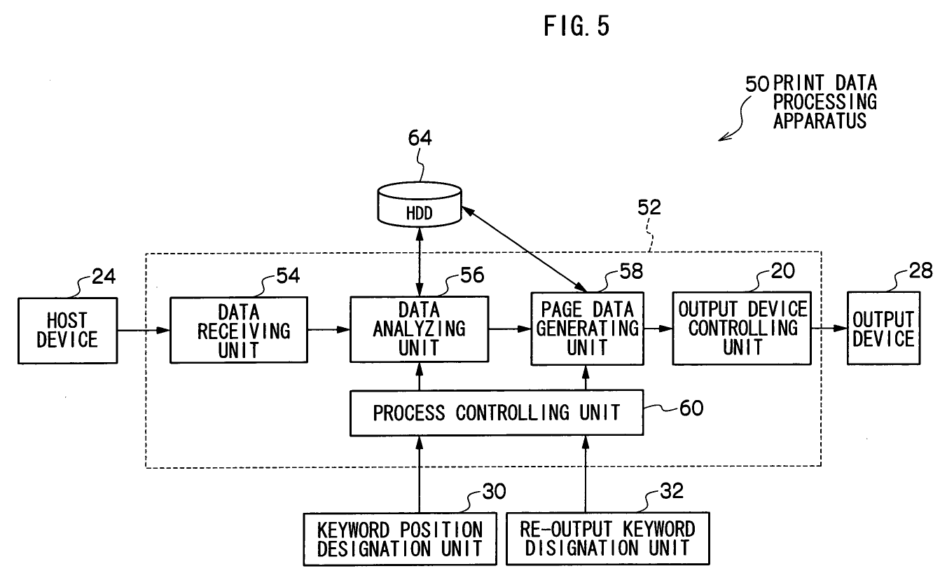

Next, a second exemplary embodiment of the present invention is described. In the following, the same components and procedures as those of the first exemplary embodiment are denoted by the same reference numerals as those used in the first exemplary embodiment, and explanation of them is omitted here. As shown in FIG. 5, a print data processing apparatus 50 of this exemplary embodiment includes a processing device 52. The processing device 52 is a microcomputer including: a ROM (not shown) that is a recording medium storing a program for executing a second data converting routine (described later in detail), a program for executing a processing routine to cause an output device 28 to output a print sheet on which an image based on print data input from a host device 24 is formed, and programs for executing various processing routines; a CPU (not shown) that reads a program out of the ROM and executes each of the processing routines; a RAM (not shown) that temporarily stores data; an I/O (input/output) port (not shown); and a bus (not shown) that connects the ROM, the CPU, the RAM, and the I/O port to one another. The functional blocks of the microcomputer that executes the second data converting routine and the processing routine for causing the output device 28 to output a print sheet on which an image based on print data input from the host device 24 is formed can be represented by a data receiving unit 54, a data analyzing unit 56, a page data generating unit 58, an output device controlling unit 20, and a process controlling unit 60.

The data receiving unit 54 is connected to the host device 24.

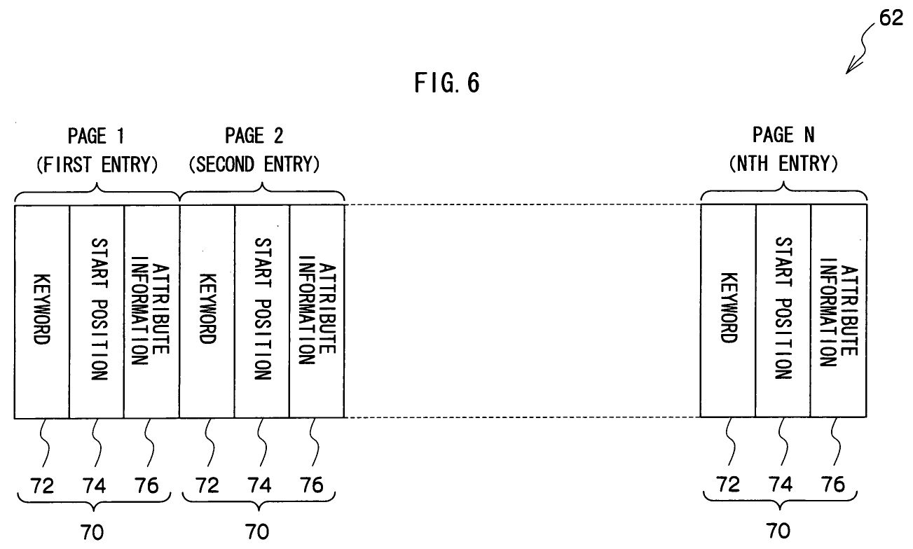

The data analyzing unit 56 is connected to a memory device 64 including a HDD (hard disk drive) that stores intermediate data that is formed by analyzing and converting the print data received by the data receiving unit 54, a reprint information table 62 shown in FIG. 6, and various kinds of information. In the reprint information table 62, the information required for performing reprinting are registered for each page of the intermediate data. The output device controlling unit 20 is connected to the output device 28 that outputs a print sheet 1200 such as a ledger sheet on which an image based on the print data input from the host device 24 is formed, as shown in FIG. 3.

The process controlling unit 60 is connected to a keyword position designation unit 30 that designates the position of a keyword so as to extract the keyword as the identification information for identifying each page of the intermediate data converted from the print data input from the host device 24, and a re-output keyword designation unit 68 that inputs a keyword indicating the page to be reprinted so as to designate the page to be reprinted.

The processing routine to be executed by the CPU of the processing device 52 to cause the output device 28 to output a print sheet on which an image based on the print data input from the host device 24 is formed is now described.

When the print data is input from the host device 24 to the processing device 52, the input print data is converted into intermediate data, and is stored in the memory device 64. The intermediate data is then converted into bitmap data. The output device 28 is controlled to output an image based on the bitmap data. This operation is performed by the respective functional blocks of the data receiving unit 54, the data analyzing unit 56, the page data generating unit 58, and the output device controlling unit 20 in the following procedures [1] through [4]:

[1] The data receiving unit 54 receives the print data input from the host device 24.

[2] The data analyzing unit 56 analyzes the print data received by the data receiving unit 54, and converts the print data into intermediate data and stores the intermediate data in the memory device 64.

[3] The page data generating unit 58 generates bitmap data from the intermediate data converted by the data analyzing unit 56, or converts the intermediate data into the bitmap data.

[4] The output device controlling unit 20 controls the output device 28 to output an image based on the bitmap data generated by the page data generating unit 58.

In the above described manner, after the print data is input from the host device 24 to the processing device 52, a paper sheet or the like on which an image based on the print data is formed is output from the output device 28.

The keyword position designation unit 30 designates the position of the keyword contained in each page of the intermediate data converted from the print data. The designation method utilized here is the same as the method, which is described in the first exemplary embodiment, for designating the position of the keyword contained in each page of the print data, and therefore, explanation of the designation method is omitted here. When keyword position information is input to the processing device 52, the CPU of the processing device 52 stores the input keyword position information in the memory device 64. This process is carried out by the process controlling unit 60 and the data analyzing unit 56. As will be described later in detail, the data analyzing unit 56 extracts the keyword contained in each page of the intermediate data converted from the print data input from the host device 24, based on the keyword position information that is input here.

The re-output keyword designation unit 68 inputs print object information containing a keyword (a re-output keyword) as the identification information indicating the page to be re-output. The input method to be utilized here is the same as the input method described in the first exemplary embodiment, and therefore, explanation of the input method is omitted here.

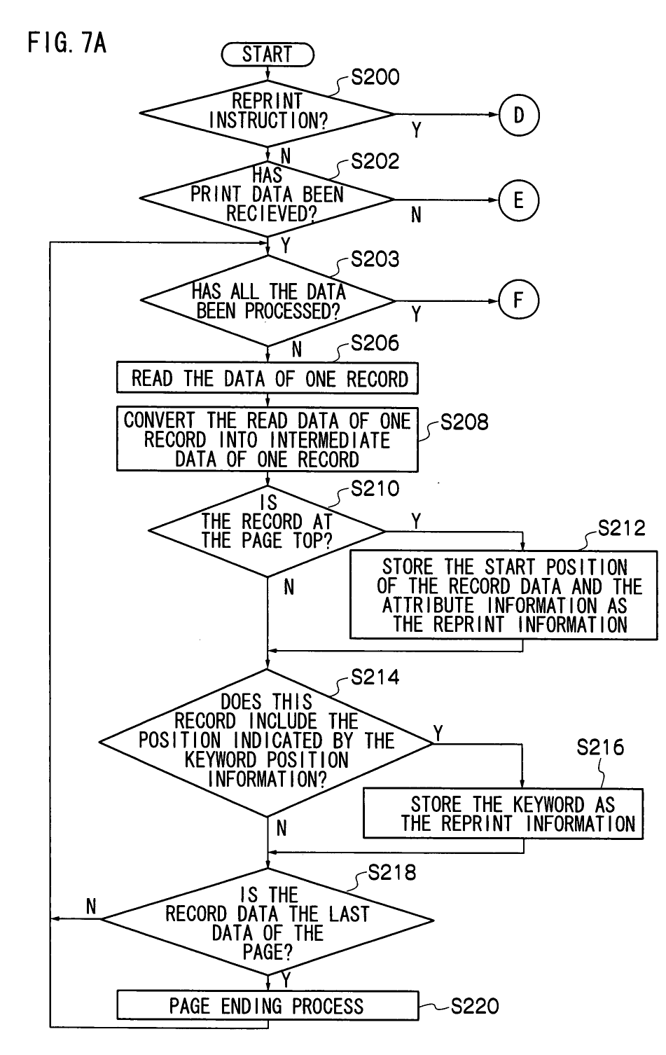

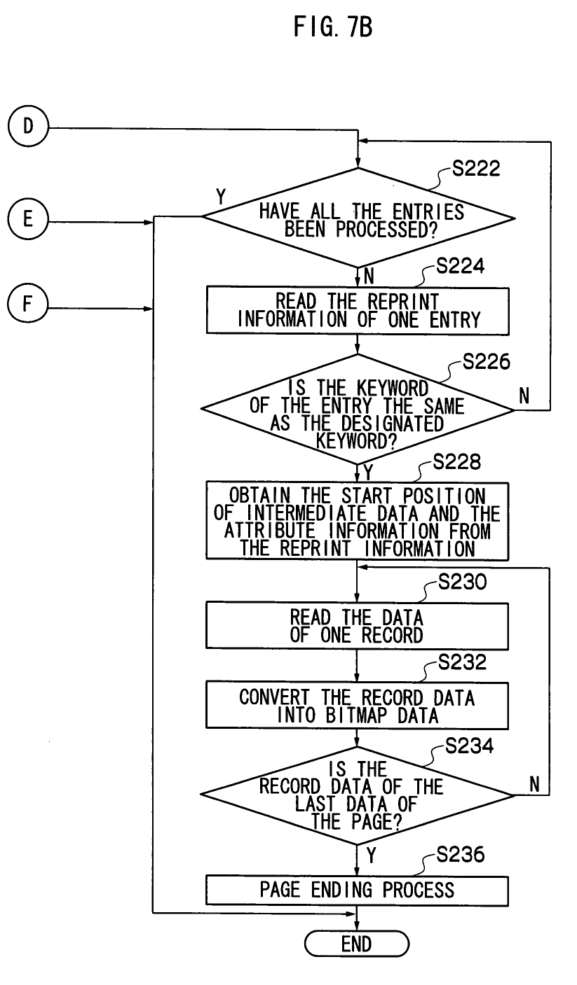

Referring now to FIG. 7A and FIG. 7B, the second data converting routine to be executed by the CPU of the processing device 52 is described. When the switch (not shown) of the print data processing apparatus 50 is switched on to supply power, this data converting routine is repeatedly executed.

At step 200, a check is made to determine whether there is a reprint instruction, or whether a keyword indicating a page to be reprinted (re-output) is input from the re-output keyword designation unit 68.

If there is a reprint instruction at step 200, the operation moves on to step 222, and the procedures of steps 222 through 236 that will be described later in detail are carried out, so as to convert the intermediate data for reprinting, such as the intermediate data of the page indicated by the keyword input from the re-output keyword designation unit 68, into bitmap data.

If there is not a reprint instruction at step 200, a check is made to determine whether print data is received from the host device 24 at step 202. If the print data is not received at step 202, the data converting routine comes to an end. If the print data is received at step 202, the procedures of steps 204 through 220 that will be described later in detail are carried out, so as to extract the keyword that is contained in the intermediate data converted from the received print data and identifies a page, and to associate the extracted keyword with the intermediate data of the corresponding page.

First, a case where the keyword that is contained in the intermediate data and identifies a page is extracted, and the extracted keyword is associated with the intermediate data of the corresponding page is described in the following.

At step 204, a check is made to determine whether the read-in process to be carried out at step 206 has been carried out for all the record data in the received print data. If the read-in process is determined to have been carried out for all the record data at step 204, the data converting routine comes to an end. If the read-in process is determined not to have been carried out for all the record data at step 204, the operation moves on to the next step 206.

At step 206, the data of one record that has not been read yet and is the closest to the page top among the record data in the received print data is read in.

At step 208, the record data read in at step 206 is converted into intermediate data.

At step 210, a check is made to determine whether the record data converted into the intermediate data at step 208 is the record data of the page top. If the record data converted into the intermediate data is determined not to be the record data of the page top at step 210, the operation moves on to step 214. If the record data converted into the intermediate data is determined to be the record data of the page top at step 210, an entry 70 for one page is newly created in the reprint information table 62 stored in the memory device 64 and shown in FIG. 6 at step 212. The information indicating the position of the record data in the intermediate data (such as the byte number counted from the top of the intermediate data) is stored at the sub entry 74 of the newly created entry 70 in the reprint information table 62. Attribute information including the print information contained in the record data is also stored at the sub entry 76 of the entry 70, and the operation moves on to step 214. Here, the print information indicates the sheet size, whether the current printing is one-side printing or two-sided printing, or whether the current printing is for a front face or a back face in the case of two-sided printing. The information indicating the position of the record data in the intermediate data converted from the received print data is also the information (data) indicating the start position of the corresponding page in the intermediate data.

At step 214, the keyword position information input from the keyword position designation unit 30 is read out from the memory device 64, and a check is made to determine whether the record data converted into intermediate data at step 208 includes the position indicated by the keyword position information which is read out from the memory device 64. If the record data converted into intermediate data is determined not to include the position indicated by the keyword position information which is read out from the memory device 64 at step 214, the operation moves on to step 218. If the record data converted into intermediate data is determined to include the position indicated by the keyword position information which is read out from the memory device 64, the operation moves on to step 216, and the keyword located in the position indicated by the keyword position information is extracted from the record data converted into intermediate data at step 208. The extracted keyword is then stored at the sub entry 72 of the corresponding entry 70 in the reprint information table 62 stored in the memory device 64, and the operation moves on to step 218.

At step 218, a check is made to determine whether the record data converted into intermediate data at step 208 is the last record data of the page. If the record data converted into intermediate data is determined not to be the last record data of the page at step 218, the operation returns to step 204, and the above described procedures are repeated. If the record data converted into intermediate data is determined to be the last record data of the page at step 218, the operation moves on to step 220. At step 220, a page ending process is carried out to integrate the intermediate data of the respective records converted at step 208 into the intermediate data of one page.

As described above, through the procedures of steps 204 through 220, the keyword that is contained in the intermediate data converted from the received print data and identifies a page is extracted, and the extracted keyword is associated with the intermediate data of the corresponding page.

An example case where a print sheet 1200 such as a ledger sheet having the positions of items (such as the customer number, name, and address) fixed in an image as shown in FIG. 3 is output from the output device 28 based on the print data input from the host device 24 to the processing device 52 is described. For example, in a case where a user inputs keyword position information indicating that the row number is “2”, the digit number is “7”, and the number of characters is “4” as the keyword contained in each page through the keyword position designation unit 30 so as to designate the four-digit number following “Customer Number:”, the four-digit number following “Customer Number:” of each page of the intermediate data converted from the print data is extracted as the keyword identifying each page at step 216. The extracted keyword is then stored at the sub entry 72 of the entry 70 of the corresponding page in the reprint information table 62 stored in the memory device 64.

Next, a case where intermediate data for reprinting, such as the intermediate data of the page indicated by the keyword input from the re-output keyword designation unit 68, is converted into bitmap data for reprinting is described below.

At step 222, a check is made to determine whether all the entries 70 of the reprint information table 62 stored in the memory device 64 have been read in at step 224. If all the entries 70 of the reprint information table 62 are determined to have been read in at step 222, the data converting routine comes to an end. If not all the entries 70 of the reprint information table 62 are determined to have been read in at step 222, the operation moves on to step 224.

At step 224, one entry is read in from the entries 70 in the reprint information table 62 stored in the memory device 64 that have not been read and are the closest to the top.

At step 226, a check is made to determine whether the keyword contained in the sub entry 72 of the entry 70 read in at step 224 is the same as the keyword designated through the re-output keyword designation unit 68. If the keyword contained in the read sub entry 72 is determined not to be the same as the designated keyword at step 226, the operation returns to step 222. If the keyword contained in the read sub entry 72 is determined to be the same as the designated keyword at step 226, the operation moves on to step 228.

At step 228, the information indicating the position of the start of the corresponding page in the intermediate data contained in the sub entry 74 of the entry 70 and the attribute information contained in the sub entry 76 are obtained from the entry 70 containing the keyword that is determined to be the same as the designated keyword at step 226.

At step 230, based on the information indicating the position of the start of the page in the intermediate data obtained at step 228, the intermediate data of the corresponding page is detected among the intermediate data stored in the memory device 64, and one record is read in from the record data that is in the intermediate data of the detected page and has not been converted into bitmap data at step 232.

At step 232, the record data of the one record read in at step 230 is converted into bitmap data.

At step 234, a check is made to determine whether the record read in at step 230 is the last record of the page. If the record is determined not to be the last record of the page at step 234, the operation returns to step 230. If the record is determined to be the last record of the page at step 234, the operation moves on to step 236. At step 236, a page ending process is carried out to integrate the bitmap data of the respective records generated at step 232 into the bitmap data of one page.

As described above, through the procedures of steps 222 through 236, the intermediate data for reprinting, such as the intermediate data of the page indicated by the keyword input from the re-output keyword designation unit 32, is converted into bitmap data.

For example, in a case where a four-digit number (“0123”, for example) following “Customer Number:” is input as the re-output keyword from the re-output keyword designation unit 68, the intermediate data of the page having the four-digit number “0123” following “Customer Number:” is converted into bitmap data for reprinting at steps 228 through 236.

Step 200 of the second data converting routine is carried out by the process controlling unit 60, step 202 is carried out by the data receiving unit 54, steps 204 through 220 are carried out by the data analyzing unit 56, and steps 222 through 236 are carried out by the page data generating unit 58.

The output device controlling unit 20 then controls the output device 28 to output a print sheet on which an image on the basis of the bitmap data generated from the intermediate data is formed.

The keyword indicating a page to be reprinted and the total print page number information indicating the total number of pages starting from the page indicated by the keyword to the page at which the reprinting is to end may be input through the re-output keyword designation unit 68. In this case, at step 228 of the second data converting routine, the information indicating the position of the start of the corresponding page in the intermediate data contained in the sub entries 76 and the attribute information contained in the sub entries 76 are obtained from the total page numbers, indicated by the total print page information, of entries 70 containing the entries 70 each containing the keyword determined to be the same as the designated keyword at step 226. At steps 230 through 234, based on the information indicating the position of the start of the corresponding page in the intermediate data obtained at step 228, the intermediate data of each corresponding page is detected among the intermediate data stored in the memory device 64, and the detected intermediate data is converted into bitmap data.

The keyword indicating a page to be reprinted and the keyword (the end identification information) indicating the page at which the reprinting starting from the page indicated by the keyword is to end may be input through the re-output keyword designation unit 68. In this case, at steps 222 through 226 of the second data converting routine, the entry 70 containing the same keyword as the keyword indicating the page to be reprinted, and the entry 70 containing the same keyword as the keyword indicating the page at which the reprinting is to end, are detected. At step 228, the information indicating the position of the start of the corresponding page in the intermediate data contained in the sub entries 74 and the attribute information contained in the sub entries 76 are obtained from the entries 70 of the pages ranging from the entry 70 detected as the entry 70 containing the same keyword as the keyword indicating the page to be reprinted to the entry 70 detected as the entry 70 containing the same keyword as the keyword indicating the page at which the reprinting is to end. At steps 230 through 234, based on the information indicating the position of the start of the corresponding page in the intermediate data obtained at step 228, the intermediate data of each corresponding page is detected from the intermediate data stored in the memory device 64, and the detected intermediate data is converted into bitmap data.

In a case where the page indicated by the keyword indicating the page to be reprinted is the back face of the page in a two-sided printing operation, it is also possible to input through the re-output keyword designation unit 68 the keyword indicating page to be reprinted and an instruction indicating that the reprinting is to be performed not only on the back face of the subject page but also on the front face of the subject page. In this case, at step 228 of the second data converting routine, the information indicating the position of the start of the corresponding page in the intermediate data contained in the sub entries 74 and the attribute information contained in the sub entries 76 are obtained from the entry 70 corresponding to the back face indicated by the same keyword as the designated keyword at step 226 and the entry 70 of the front face of the same page as the back face. At steps 230 through 234, based on the information indicating the position of the start of the corresponding page in the intermediate data obtained at step 228, the intermediate data of the corresponding page is detected from the intermediate data stored in the memory device 64, and the detected intermediate data is converted into the bitmap data.

The method to be utilized by the keyword position designation unit 30 to designate the position of the keyword contained in each page of print data may be a method for designating a character string accompanied with the keyword which is located in the position to be designated. For example, in a case where the output device 28 is to output a print sheet 1200 such as a ledger sheet having the positions of the respective items (such as a customer number, name, and address) fixed in an image in advance, as shown in FIG. 3, based on print data that is input from the host device 24 to the processing device 52, a user may designate the position of the keyword contained in each page in the following manner. To designate a four-digit number following “Customer Number:” as the keyword contained in each page, the user may input the keyword position information indicating that the keyword to be designated should follow the character string “Customer Number:”. For example, the character string to be accompanied with the keyword, such as the character string “Customer Number:”, may be input through the input screen on the display with the use of the keyboard.

### THIRD EXEMPLARY EMBODIMENT

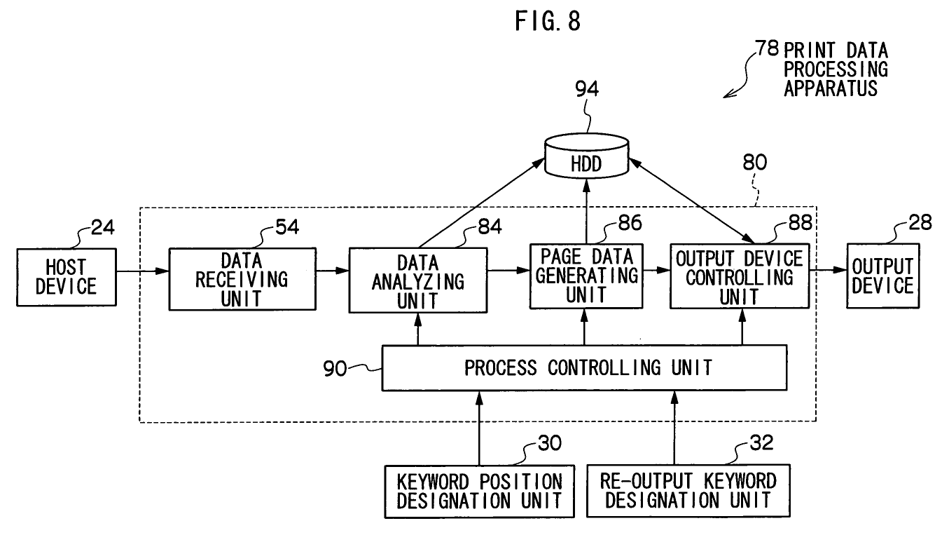

Next, a third exemplary embodiment of the present invention is described. In the following, the same components and procedures as those of the first exemplary embodiment and the second exemplary embodiment are denoted by the same reference numerals as those used in the first exemplary embodiment and the second exemplary embodiment, and explanation of them is omitted here. As shown in FIG. 8, a print data processing apparatus 78 of this exemplary embodiment includes a processing device 80. The processing device 80 is a microcomputer including: a ROM (not shown) that is a recording medium storing a program for executing a third data converting routine (described later in detail), a program for executing a processing routine to cause an output device 28 to output a print sheet on which an image based on print data input from a host device 24 is formed, and programs for executing various processing routines; a CPU (not shown) that reads a program out of the ROM and executes each of the processing routines; a RAM (not shown) that temporarily stores data; an I/O (input/output) port (not shown); and a bus (not shown) that connects the ROM, the CPU, the RAM, and the I/O port to one another. The functional blocks of the microcomputer that executes the third data converting routine and the processing routine for causing the output device 28 to output a print sheet on which an image based on print data input from the host device 24 is formed can be represented by a data receiving unit 54, a data analyzing unit 84, a page data generating unit 86, an output device controlling unit 88, and a process controlling unit 90.

The data receiving unit 54 is connected by the data analyzing unit 84 to the host device 24 that outputs print data for performing printing in accordance with an instruction or the like issued from a user.

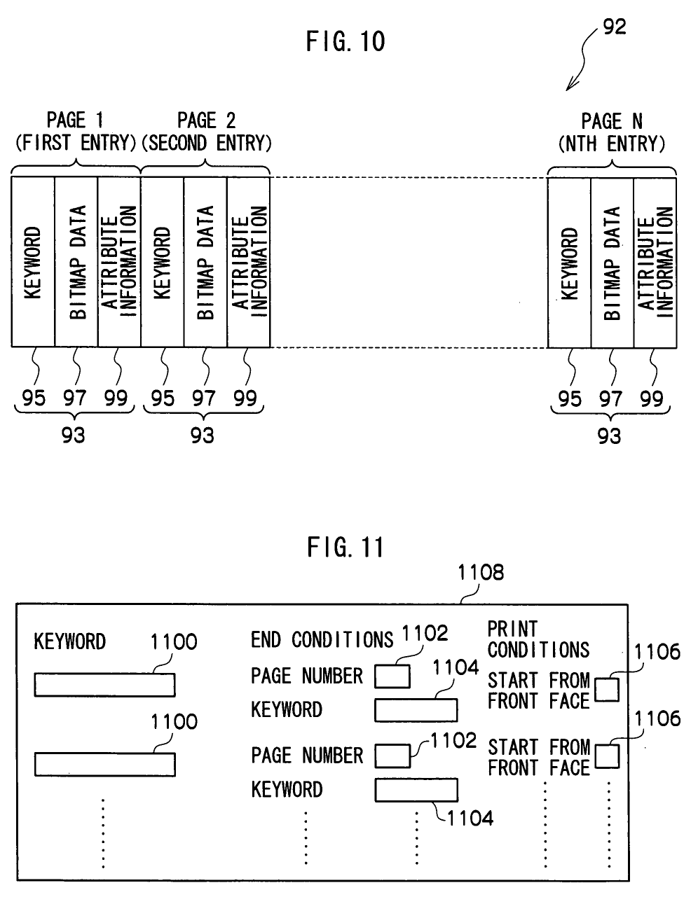

The page data generating unit 86 is connected to a memory device 94 including a HDD (hard disk drive) that stores bitmap data that is generated from intermediate data converted from the print data received by the data receiving unit 54, a reprint information table 92 shown in FIG. 10, and various kinds of information. In the reprint information table 92, the information required for performing reprinting are registered for each page of the bitmap data. The output device controlling unit 88 is connected to the output device 28 that outputs a print sheet 1200 on which an image based on the print data input from the host device 24 is formed, as shown in FIG. 3.

The process controlling unit 90 is connected to a keyword position designation unit 30 that designates the position of a keyword so as to extract the keyword as the identification information for identifying each page of the intermediate data converted from the print data input from the host device 24, and a re-output keyword designation unit 32 that inputs a keyword indicating the page to be reprinted so as to designate the page to be reprinted.

The processing routine, which is executed by the CPU of the processing device 80, to cause the output device 28 to output a print sheet on which an image based on the print data input from the host device 24 is formed is now described.

When the print data is input from the host device 24 to the processing device 80, the input print data is converted into intermediate data, and the intermediate data is converted into bitmap data. The converted bitmap data is stored in the memory device 94. The output device 28 is controlled to output an image based on the bitmap data. This operation is performed by the respective functional blocks of the data receiving unit 54, the data analyzing unit 84, the page data generating unit 86, and the output device controlling unit 88 in the following procedures [1] through [4]:

[1] The data receiving unit 54 receives the print data input from the host device 24. e data analyzing unit 84 analyzes the print data received by the data receiving unit 54, and converts the print data into intermediate data.

[3] The page data generating unit 86 generates bitmap data from the intermediate data converted by the data analyzing unit 84, or converts the intermediate data into the bitmap data, and stores the bitmap data in the memory device 94.

[4] The output device controlling unit 88 controls the output device 28 to output an image based on the bitmap data generated by the page data generating unit 86.

In the above described manner, after the print data is input from the host device 24 to the processing device 80, a paper sheet or the like on which an image based on the print data is output from the output device 28 is formed.

The keyword position designation unit 30 designates the position of the keyword contained in each page of the intermediate data converted from the print data. The designation method utilized here is the same as the method, which is described in the first exemplary embodiment, for designating the position of the keyword contained in each page of the print data, and therefore, explanation of the designation method is omitted here. When keyword position information is input to the processing device 80, the CPU of the processing device 80 stores the input keyword position information in the memory device 94. This process is carried out by the process controlling unit 90 and the data analyzing unit 86. As will be described later in detail, the data analyzing unit 56 extracts the keyword contained in each page of the intermediate data converted from the print data input from the host device 24, based on the keyword position information that is input here.

The re-output keyword designation unit 32 inputs print object information containing a keyword (a re-output keyword) as the identification information indicating the page to be re-output. The input method to be utilized here is the same as the input method described in the first exemplary embodiment, and therefore, explanation of the input method is omitted here.

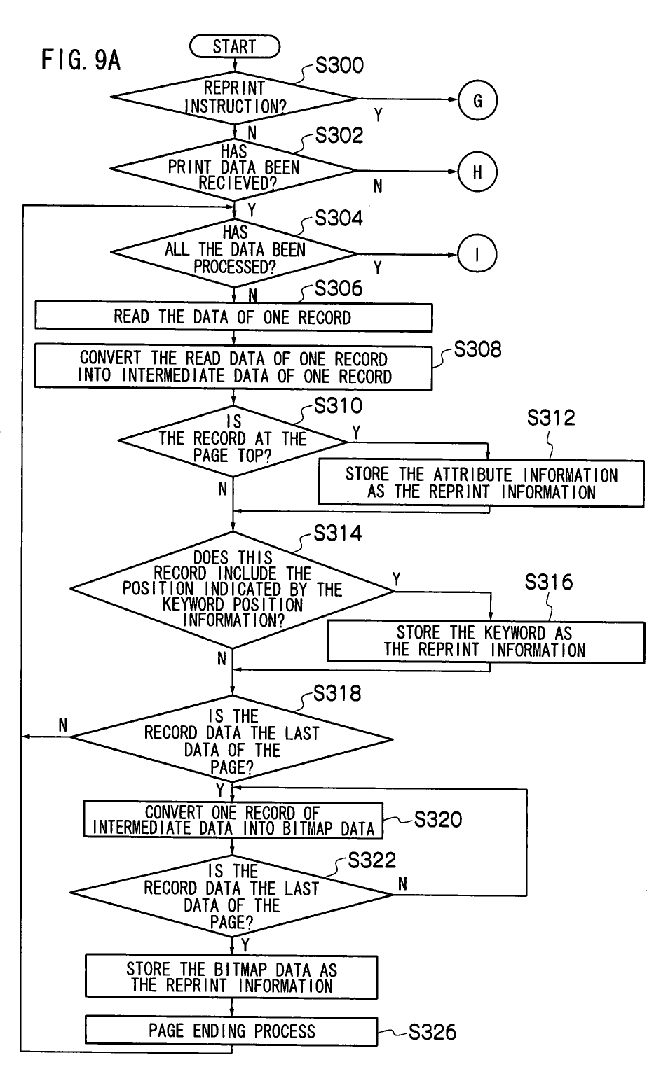

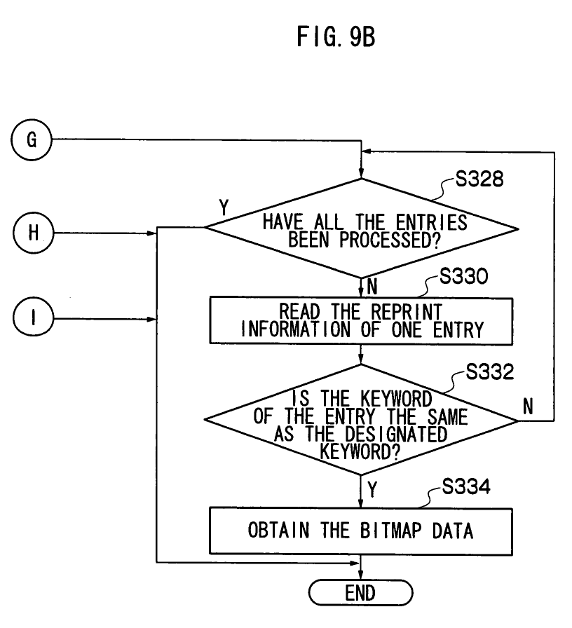

Referring now to FIG. 9A and FIG. 9B, the third data converting routine to be executed by the CPU of the processing device 80 is described. When the switch (not shown) of the print data processing apparatus 78 is switched on to supply power, this data converting routine is repeatedly executed.

At step 300, a check is made to determine whether there is a reprint instruction, or whether a keyword indicating a page to be reprinted (re-output) is input from the re-output keyword designation unit 32.

If there is a reprint instruction at step 300, the operation moves on to step 328, and the procedures of steps 328 through 334 that will be described later in detail are carried out, so as to obtain bitmap data for reprinting or the bitmap data of the page indicated by the keyword input from the re-output keyword designation unit 32.

If there is not a reprint instruction at step 300, a check is made to determine whether print data is received from the host device 24 at step 302. If the print data is not received at step 302, the data converting routine comes to an end. If the print data is received at step 302, the procedures of steps 304 through 326 that will be described later in detail are carried out, so as to extract the keyword that is contained in the intermediate data converted from the received print data and identifies a page, and to associate the extracted keyword with the bitmap data of the corresponding page.

First, a case where the keyword that is contained in the intermediate data converted from the received print data and identifies each page is extracted, and the extracted keyword is associated with the bitmap data of the corresponding page is described in the following.

At step 304, a check is made to determine whether the read-in process to be carried out at step 306 has been carried out for all the record data in the received print data. If the read-in process is determined to have been carried out for all the record data at step 304, the data converting routine comes to an end. If the read-in process is determined not to have been carried out for all the record data at step 304, the operation moves on to the next step 306.

At step 306, the data of one record that has not been read yet and is the closest to the page top among the record data in the received print data is read in.

At step 308, the record data read in at step 306 is converted into intermediate data.

At step 310, a check is made to determine whether the record data of the intermediate data converted at step 308 is the record data of the page top. If the read record data of the converted intermediate data is determined not to be the record data of the page top at step 310, the operation moves on to step 314. If the record data of the converted intermediate data is determined to be the record data of the page top at step 310, an entry 93 for one page is newly created in the reprint information table 92 stored in the memory device 94 and shown in FIG. 10 at the next step 312. Attribute information including the print information contained in the record data is stored at the sub entry 99 of the entry 93 newly created in the reprint information table 92, and the operation moves on to step 314. Here, the print information indicates the sheet size, whether the current printing is one-side printing or two-sided printing, or whether the current printing is for a front face or a back face in the case of two-sided printing.

At step 314, a check is made to determine whether the record data converted into intermediate data at step 308 includes the position indicated by keyword position information that is input from the keyword position designation unit 30. If the record data converted into the intermediate data is determined not to include the position indicated by the read keyword position information at step 314, the operation moves on to step 318. If the record data converted into the intermediate data is determined to include the position indicated by the read keyword position information, the operation moves on to step 316. At step 316, the keyword located in the position indicated by the keyword position information is extracted from the record data converted into intermediate data at step 308. The extracted keyword is then stored at the sub entry 95 of the corresponding entry 93 in the reprint information table 92 stored in the memory device 94, and the operation moves on to step 318.

At step 318, a check is made to determine whether the record data converted into intermediate data at step 308 is the last record data of the page. If the record data converted into intermediate data is determined not to be the last record data of the page at step 318, the operation returns to step 304, and the above described procedures are repeated. If t the record data converted into intermediate data is determined to be the last record data of the page at step 318, the operation moves on to step 320. At step 320, a page ending process is carried out to integrate the intermediate data of the respective records converted at step 308 into the intermediate data of one page. At the same time, one record of record data of the intermediate data of a page unit that has had the page ending process applied thereto, and that has not been read, is read in from the page top, and the read record data is converted into bitmap data.

At step 322, a check is made to determine whether the record of the bitmap data generated at step 320 is the last record of the page. If the record of the generated bitmap data is determined not to be the last record of the page at step 322, the operation returns to step 320. If the record of the generated bitmap data is determined to be the last record of the page at step 322, the operation moves on to step 324.

At step 324, the bitmap data, which has been generated at step 320, of the respective records is integrated into the bitmap data of one page, and the integrated bitmap data of each page is stored at the sub entry 97 of the corresponding entry 93 in the reprint information table 92 stored in the memory device 94.

As described above, through the procedures of steps 304 through 326, the keyword that is contained in the intermediate data converted from the received print data and identifies each page is extracted, and the extracted keyword of each page is associated with the bitmap data of each corresponding page.

An example case where a print sheet 1200 such as a ledger sheet having the positions of items (such as the customer number, name, and address) fixed in an image as shown in FIG. 3 is output from the output device 28 based on the print data input from the host device 24 to the processing device 80 is described. For example, in a case where a user inputs keyword position information indicating that the row number is “2”, the digit number is “7”, and the number of characters is “4” as the keyword contained in each page through the keyword position designation unit 30 so as to designate the four-digit number following “Customer Number:”, the four-digit number following “Customer Number:” of each page of the intermediate data converted from the print data is extracted as the keyword identifying each page at step 316. The extracted keyword is then stored at the sub entry 95 of the entry 93 of the corresponding page in the reprint information table 92 stored in the memory device 94. At step 324, the bitmap data of each page is stored at the sub entry 97 of each corresponding entry 93.

Next, a case where bitmap data for reprinting, such as the bitmap data of the page indicated by the keyword input from the re-output keyword designation unit 32, is to be obtained is described below.

At step 328, a check is made to determine whether all the entries 93 of the reprint information table 92 stored in the memory device 94 have been read in at step 330. If all the entries 93 of the reprint information table 92 are determined to have been read in at step 328, the data converting routine comes to an end. If not all the entries 93 of the reprint information table 92 are determined to have been read in at step 328, the operation moves on to step 330.

At step 330, one entry is read in from the entries 93 that have not been read in the reprint information table 92 stored in the memory device 94 and are the closest to the top.

At step 332, a check is made to determine whether the keyword contained in the sub entry 95 of the entry 93 read in at step 330 is the same as the keyword designated through the re-output keyword designation unit 32. If the keyword contained in the read sub entry 95 is determined not to be the same as the designated keyword at step 332, the operation returns to step 328. If the keyword contained in the read sub entry 95 is determined to be the same as the designated keyword at step 332, the operation moves on to step 334.

At step 334, the bitmap data contained in the sub entry 97 of the entry 93 and the attribute information contained in the sub entry 99 are obtained from the entry 93 containing the keyword that is determined to be the same as the designated keyword at step 332.

As described above, through the procedures of steps 328 through 334, the bitmap data for reprinting, such as the bitmap data of the page indicated by the keyword input from the re-output keyword designation unit 32, is obtained.

For example, in a case where a four-digit number (“0123”, for example) following “Customer Number:” is input as the re-output keyword from the re-output keyword designation unit 32, the bitmap data of the page having the four-digit number “0123” following “Customer Number:” is obtained at steps 328 through 334.

Step 300 of the third data converting routine is carried out by the process controlling unit 90, step 302 is carried out by the data receiving unit 54, steps 304 through 318 are carried out by the data analyzing unit 84, steps 320 through 326 are carried out by the page data generating unit 86, and steps 328 through 334 are carried out by the output device controlling unit 88.

The output device controlling unit 88 then controls the output device 28 to output a print sheet on which an image on the basis of the obtained bitmap data is formed.

The keyword indicating a page to be reprinted and the total print page number information indicating the total number of pages starting from the page indicated by the keyword to the page at which the reprinting is to end may be input through the re-output keyword designation unit 32. In this case, at step 334 of the third data converting routine, the bitmap data for reprinting that is contained in the sub entries 97 and the attribute information contained in the sub entries 99 are obtained from the total page numbers, indicated by the total print page information, of entries 93 containing the entries 93 each containing the keyword determined to be the same as the designated keyword at step 332.

The keyword indicating a page to be reprinted and the keyword (the end identification information) indicating the page at which the reprinting starting from the page indicated by the keyword is to end may be input through the re-output keyword designation unit 32. In this case, at steps 328 through 332 of the third data converting routine, the entry 93 containing the same keyword as the keyword indicating the page to be reprinted, and the entry 93 containing the same keyword as the keyword indicating the page at which the reprinting is to end, are detected. At step 334, the bitmap data for reprinting that is contained in the sub entries 97 and the attribute information contained in the sub entries 99 are obtained from the entries 93 of the pages ranging from the entry 93 detected as the entry 70 containing the same keyword as the keyword indicating the page to be reprinted to the entry 93 detected as the entry 93 containing the same keyword as the keyword indicating the page at which the reprinting is to end.

In a case where the page indicated by the keyword indicating the page to be reprinted is the back face of the page in a two-sided printing operation, it is also possible to input through the re-output keyword designation unit 32 the keyword indicating the page to be reprinted and an instruction indicating that the reprinting is to be performed not only on the back face of the subject page but also on the front face of the subject page. In this case, at step 334 of the third data converting routine, the bitmap data for reprinting that is contained in the sub entries 97 and the attribute information contained in the sub entries 99 are obtained from the entry 93 corresponding to the back face indicated by the same keyword as the designated keyword at step 332 and the entry 93 of the front face of the same page as the back face.

The method to be utilized by the keyword position designation unit 30 to designate the position of the keyword contained in each page of print data may be a method for designating a character string accompanied with the keyword is located in the position to be designated. For example, in a case where the output device 28 is to output a print sheet 1200 such as a ledger sheet having the positions of the respective items (such as a customer number, name, and address) fixed in an image in advance, as shown in FIG. 3, based on print data that is input from the host device 24 to the processing device 80, a user may designate the position of the keyword contained in each page in the following manner. To designate a four-digit number following “Customer Number:” as the keyword contained in each page, the user may input the keyword position information indicating that the keyword to be designated should follow the character string “Customer Number:”. For example, the character string to be accompanied with the keyword, such as the character string “Customer Number:”, may be input through the input screen on the display with the use of the keyboard.

Although the identification information indicating a page is a keyword in each of the above described exemplary embodiments, it may be a symbol or a figure.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A print data processing apparatus comprising:
a position designation unit that designates a position of identification information in each page of data to be printed, the identification information identifying the page;
an extraction unit that extracts the identification information contained in each page of the data, based on the position designated by the position designation unit;
a memory that stores the identification information extracted by the extraction unit and the data corresponding to the page containing the identification information, the identification information being associated with the data;
an input unit that inputs print object information containing the identification information indicating a page to be reprinted; and
a controller that performs a control operation so that the data of the page corresponding to the print object information input from the input unit is output from the memory, based on the print object information input from the input unit and the identification information stored in the memory.

2. The print data processing apparatus according to claim 1, wherein the data to be printed is print data sent from an external device located outside the print data processing apparatus.

3. The print data processing apparatus according to claim 1, wherein the data to be printed is intermediate data converted from print data, the print data sent from an external device located outside the print data processing apparatus.

4. The print data processing apparatus according to claim 1, wherein the print object information includes two-sided print information for performing printing on both sides of each sheet in a case of two-sided printing, total print number information indicating the total number of pages to be reprinted, or end identification information indicating a page at which reprinting is to end.

5. The print data processing apparatus according to claim 1, wherein the identification information is a keyword, a symbol, or a figure that is contained in the data.

6. The print data processing apparatus according to claim 1, further comprising an output unit that outputs an image onto a print sheet, based on the data that is output from the memory.

7. A print data processing apparatus comprising:
a position designation unit that designates a position of identification information in each page of intermediate data, the identification information identifying each page;
a conversion unit that converts the intermediate data into bitmap data;
an extraction unit that extracts the identification information contained in each page of the intermediate data, based on the position designated by the position designation unit;
a memory that stores the identification information extracted by the extraction unit and the bitmap data that is converted by the conversion unit from the intermediate data corresponding to the page containing the identification information, the identification information being associated with the bitmap data;
an input unit that inputs print object information containing the identification information indicating a page to be reprinted; and
a controller that performs a control operation so that the bitmap data of the page corresponding to the print object information input from the input unit is output from the memory, based on the print object information input from the input unit and the identification information stored in the memory.

8. The print data processing apparatus according to claim 7, wherein the print object information includes two-sided print information for performing printing on both sides of each sheet in a case of two-sided printing, total print number information indicating the total number of pages to be reprinted, or end identification information indicating a page at which reprinting is to end.

9. The print data processing apparatus according to claim 7, wherein the identification information is a keyword, a symbol, or a figure that is contained in the intermediate data.

10. The print data processing apparatus according to claim 7, further comprising an output unit that outputs an image onto a print sheet, based on the bitmap data that is output from the memory.

11. A print data conversion method comprising:
designating a position of identification information in each page of data to be printed, the identification information identifying each page;
extracting the identification information contained in each page of the data, based on the designated position;
storing the extracted identification information and the data corresponding to the page containing the identification information in a memory, the identification information being associated with the data; and
performing a control operation so that the data of the page corresponding to print object information input from an input unit is output from the memory, based on the print object information input from the input unit and the identification information stored in the memory, the print object information indicating a page to be reprinted.

12. The print data conversion method according to claim 11, wherein the print object information includes two-sided print information for performing printing on both sides of each sheet in a case of two-sided printing, total print number information indicating the total number of pages to be reprinted, or end identification information indicating a page at which reprinting is to end.

13. The print data conversion method according to claim 11, wherein the identification information is a keyword, a symbol, or a figure that is contained in the data.

14. The print data conversion method according to claim 11, further comprising outputting an image onto a print sheet, based on the data that is output from the memory.

15. A print data conversion method comprising:
designating a position of identification information in each page of intermediate data, the identification information identifying each page;
converting the intermediate data into bitmap data;
extracting the identification information contained in each page of the intermediate data, based on the designated position;
storing the extracted identification information and the bitmap data converted from the intermediate data corresponding to the page containing the identification information in a memory, the identification information being associated with the bitmap data; and
performing a control operation so that the bitmap data of the page corresponding to print object information input from an input unit is output from the memory, based on the print object information input from the input unit and the identification information stored in the memory, the print object information indicating a page to be reprinted.

16. A computer readable medium storing a program causing a computer to execute a process for reprinting, the process comprising:
designating a position of identification information in each page of data to be printed, the identification information identifying each page;
extracting the identification information contained in each page of the data, based on the designated position;
storing the extracted identification information and the data corresponding to the page containing the identification information in a memory, the identification information being associated with the data; and
performing a control operation so that the data of the page corresponding to print object information input from an input unit is output from the memory, based on the print object information input from the input unit and the identification information stored in the memory, the print object information indicating a page to be reprinted.
